(19) United States
(12) Patent Application Publication
(10) Pub. No.: US 2011/0029592 A1
(43) Pub. Date: Feb. 3, 2011

(54) COMPUTERIZED METHOD OF ORGANIZING AND DISTRIBUTING ELECTRONIC HEALTHCARE RECORD DATA

(75) Inventors: Robert Downey, Boston, MA (US); Mike Dow, Brookline, MA (US)

Correspondence Address: HOWARD & HOWARD ATTORNEYS PLLC, 450 West Fourth Street, Royal Oak, MI, 48067, US

(73) Assignee: GALEN HEATHCARE SOLUTIONS INC., Grosse Pointe, MI (US)

(21) Appl. No.: 12/510,600

(22) Filed: Jul. 28, 2009

(51) Int. Cl. G06Q 50/00; G06F 15/16; G06F 17/30

(52) U.S. Cl. 709/203; 705/2; 707/E17.032

(57) ABSTRACT

A system and method for organizing and distributing electronic healthcare records (EHRs) copies the EHRs from an EHR database to a separate, remote server computer. The remote server generates viewable and printable electronic documents from the EHRs while omitting information that is not needed by the healthcare professional viewing the electronic documents. Electronic documents for patient appointments in a predetermined window are transferred from the remote server to client computers located in a health care facility. The electronic documents may also be transferred between the client computers to save on network bandwidth from the server computer. The server computer routinely updates the electronic documents based on new EHRs received form the EHR database. Stale electronic documents with out-of-date information are tagged as such.

### BACKGROUND OF THE INVENTION

1. Field of the Invention

The subject invention relates to medical records stored and accessed as computerized data.

2. Description of the Related Art

Healthcare and medical records have traditionally been kept in paper form. However, recently there has been a migration to electronic record keeping. The advantages of electronic healthcare records are many: less storage space required, environmental concerns from less paper, easy transportation and sharing of digital files between healthcare providers, etc.

Unfortunately, many difficulties with electronic healthcare record (EHR) data have arisen as this transition between paper and electronic record keeping progresses. For instance, the computers storing EHR data are prone to interruption and/or failure due to hardware problems, software issues, or routine maintenance. Also, problems with telecommunication networks linking the EHR data and the healthcare provider often are interrupted. As such, the provider may not have instant access to a patient's records. Furthermore, EHR data is stored and provided in a format that is often not useful to healthcare providers, i.e., the healthcare providers often cannot understand the raw EHR data or are not concerned with all of the raw EHR data as it pertains to each patient examination.

The subject invention addresses and solves these and other difficulties.

### SUMMARY OF THE INVENTION AND ADVANTAGES

One aspect of the invention provides a method of organizing and distributing electronic healthcare record (EHR) data using a computerized system. The system includes a server computer in communication with an EHR database. The method includes periodically transferring EHR data from the EHR database to the server computer. Appointment data is stored on the server computer. The appointment data includes a scheduled time of an appointment and at least one category of EHR data necessary for the appointment. The method also includes the step of analyzing the appointment data to determine appointments scheduled within a range of times. The EHR data is filtered based on the at least one category of EHR data necessary for the appointment to generate filtered EHR data. The method further includes the step of generating at least one electronic document. Each document includes the filtered EHR data for each appointment scheduled within the range of times. Furthermore, each electronic document is readable by a health care provider.

Another aspect of the invention presents a method of distributing EHR data using a computerized system. The system includes a server computer in communication with an EHR database and a plurality of client computers in communication with the server computer. The method includes the step of periodically transferring EHR data from the EHR database to the server computer. At least one electronic document that is readable by a health care provider is generated from the EHR data for each appointment. The method also includes the step of communicating the at least one electronic document from the server computer to at least one of the client computers. The method further includes the step of transferring the at least one electronic document from the at least one of the client computers to another of the client computers separate from the at least one of the client computers.

Yet another aspect of the present invention presents a method of organizing and distributing EHR data using a computerized system. The system including a server computer in communication with an EHR database. The method includes the steps of maintaining a copy of the EHR data on the server computer and maintaining at least one electronic document generated from the EHR data on the server computer. The method also includes the step of periodically transferring from the EHR database to the server computer only new EHR data which is different from the EHR data on the server computer. It is then determined if the at least one electronic document needs to be updated based on the new EHR data received at the server computer. In response to the at least one electronic document needing to be updated, at least one new electronic document including the new EHR data is generated.

The present invention provides numerous advantages over the prior art. First, the method filters the EHR data so that extraneous data is not presented to a health care provider in the electronic documents. This allows the health care provider to more quickly and efficiently analyze the EHR data. By utilizing client-to-client computer communication, the method saves on communication bandwidth and allows for speedy downloads of electronic documents. Furthermore, the electronic documents are automatically refreshed when the EHR data is changed are updated, so that the health care provider has the most accurate data at hand.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic block diagram showing an exemplary system used with the present invention showing an electronic healthcare record (EHR) database, a server computer, and a plurality of client computers;

FIG. 2 is a schematic block diagram showing an alternative system used with the present invention showing the EHR database and server computer being apart from one another;

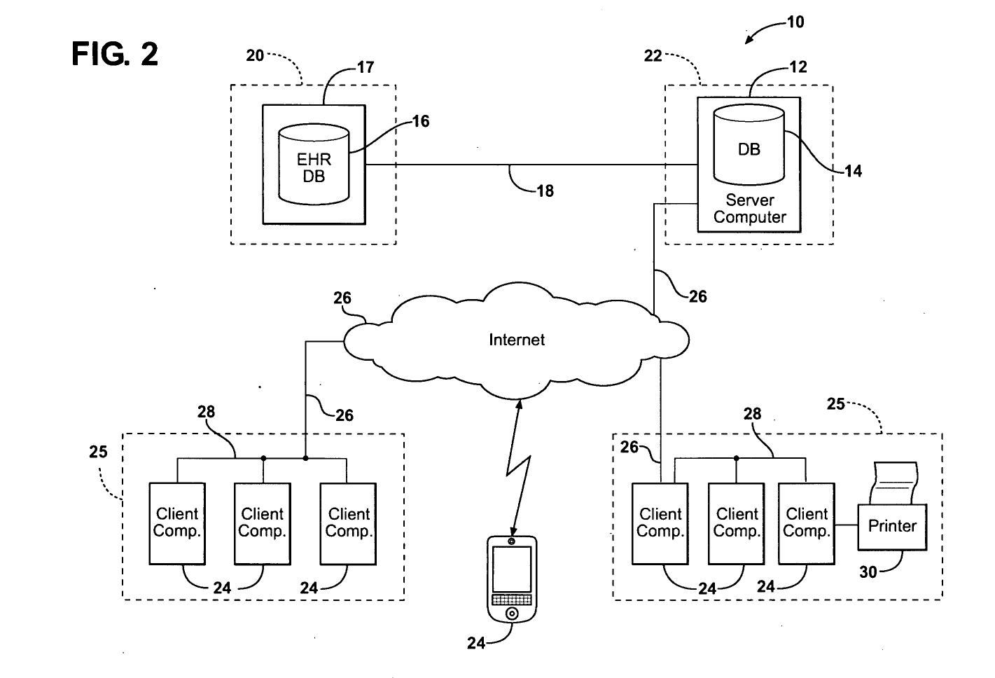

FIG. 3 is a flowchart showing generation of electronic documents according to one aspect of the present invention; and

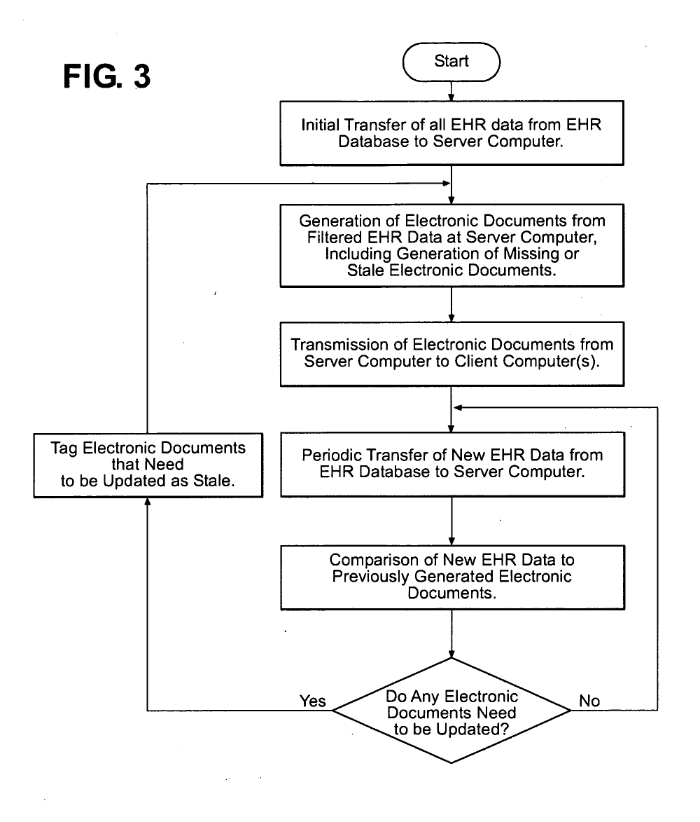

FIG. 4 is a flowchart showing transfer of electronic documents to client computers according to another aspect of the present invention.

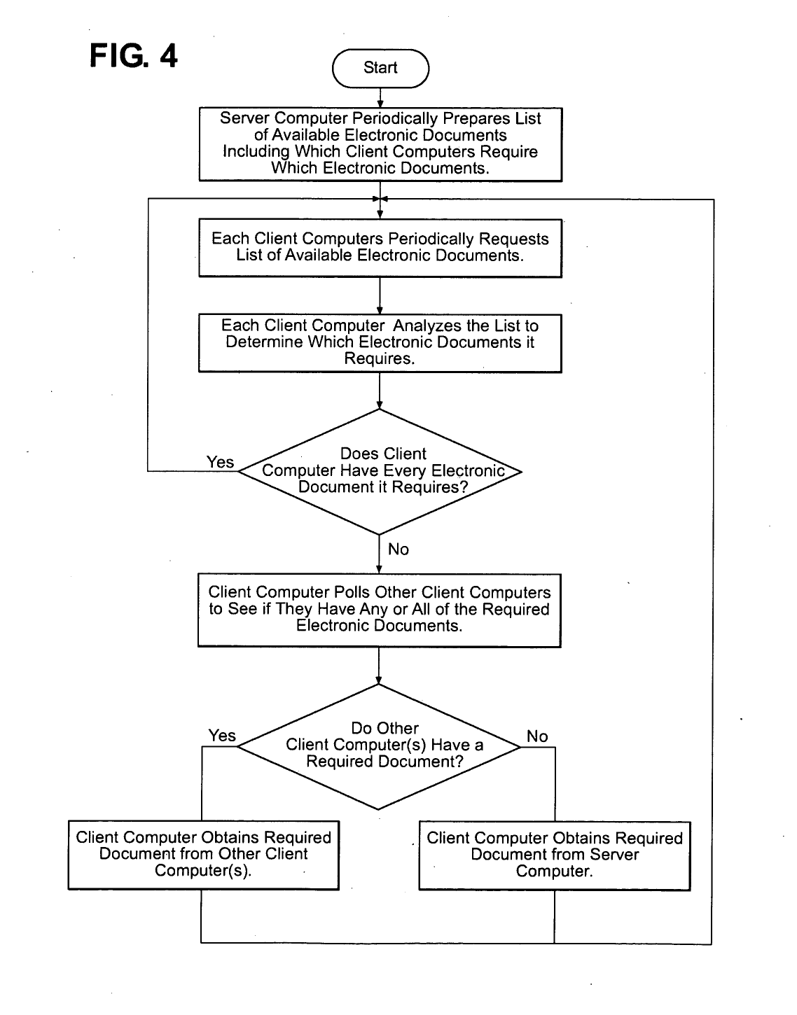

### DETAILED DESCRIPTION OF THE INVENTION

Referring to the Figures, a method of organizing and distributing electronic healthcare record (EHR) data and an exemplary system 10 is shown herein.

EHR data, also commonly referred to as electronic health record data or electronic medical record (EMR) data, may include various information about the health and healthcare of a patient. For instance, the EHR data may include, but is not limited to, demographics, problem lists, medications, allergies, visit notes, laboratory and radiology results, vital signs, and immunizations. The EHR data is typically used by a health care professional, such as, but not limited to, a physician (e.g., a doctor), a nurse, a physician's assistant (e.g., a P.A.), dentist, or a veterinarian. The EHR data is typically used in analyzing, diagnosing, and treating of a patient. The patient may be a human being or, in the case of use by a veterinarian, some other animal. Furthermore, the EHR data may be used by other scientists for research purposes.

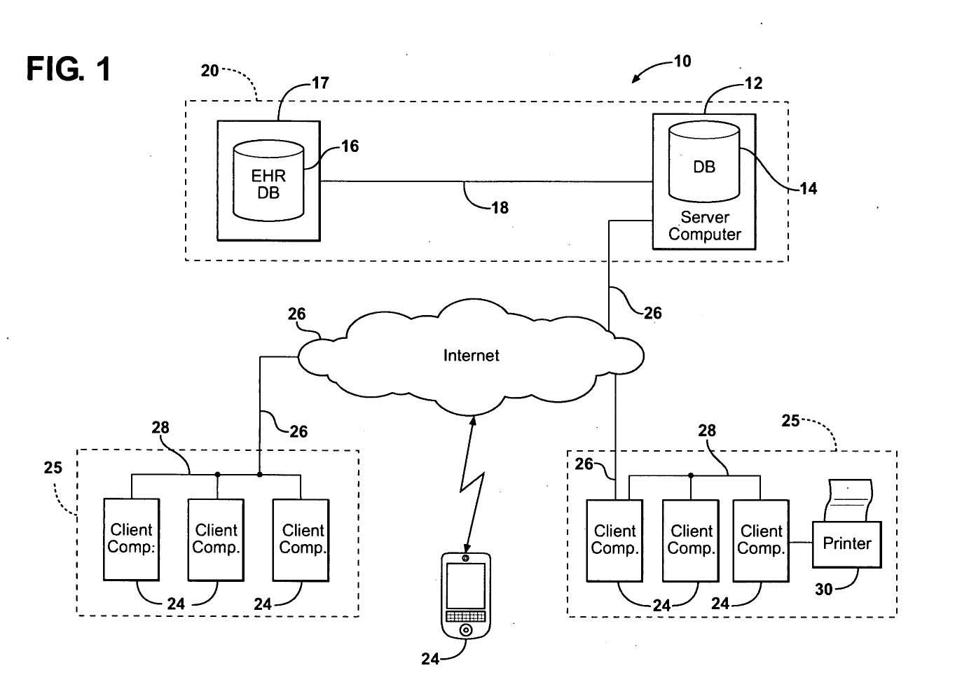

Referring to FIG. 1, the exemplary system 10 includes a server computer 12. The server computer 12 includes at least one microprocessor (not shown) which runs one or more software program products, some of which are described in detail herein. The server computer includes at least one database 14 for storing data, including, but not limited to, EHR data, appointment data, and/or other patient information, as described in greater detail below. The data of the at least one database 14 may be stored on a disk drive, electronic memory, and/or other data storage devices well known to those skilled in the art.

The server computer 12 is in communication with an EHR database 16. That is, data, including EHR data, may be transferred between the server computer 12 and the EHR database 16. The EHR database 16, as is readily appreciated by those skilled in the art, is stored in a database server 17, i.e., a computer. In one exemplary embodiment, the EHR database 16 is operated and maintained by Allcripts-Misys Healthcare Solutions, Inc. headquartered in Chicago, Ill. However, other implementations of the EHR database 16 by other providers may also be accommodated by the present invention.

The EHR database 16 and the server computer 12 are typically located near another at a first location 20 and in communications with each other via a database-to-server communications link 18. However, the EHR database 16 and the server computer 12 may be located remote from one another. That is, the EHR database 16 may be located at the first location 20 while the server computer 12 is located at a second location 22 distant from the first location 20. The database-to-server communications link 18 may be implemented through a direct data connection, a local area network (LAN), the Internet, a dedicated point-to-point transmission line, wireless devices, or other form of communication technique known to those skilled in the art. Preferably, the data transferred between the EHR database 16 and the server computer 12 is encrypted.

Unfortunately, hardware or software failures related to the EHR database 16, interruptions or failures of the communications link 18 or related communications devices (not shown), or other malfunctions may occur from time-to-time, which results in a loss of communications between the server computer 12 and the EHR database 16. As such, data is not communicated between the server computer 12 and the EHR database 16 when such a loss of communications occurs.

The EHR data may be categorized into a plurality of categories for sorting and/or arranging the EHR data. For example, the EHR data may be broken down into a demographics category, a problem lists category, a medications category, an allergies category, a visit notes category, a laboratory and radiology results category, a vital signs category, and an immunizations category. Furthermore, the categories may be temporal based, such as, data from the last month, last year, or last 10 years. Other categories for the EHR data are known to and will be appreciated by those skilled in the art.

The system 10 further includes a plurality of client computers 24. The client computers 24 are typically located at healthcare provider locations 25, such as, but certainly not limited to, a doctor's office, a medical clinic, a hospital, and a medical testing facility. The client computers 24 may be portable devices that are easily moved and not fixed to a specific location. For example, the client computer 24 may be implemented as a laptop computer, a personal digital assistant, a mobile (or cellular) phone, a tablet computer, or a portable reading device (e.g., the Kindle device sold by amazon.com). Of course, those skilled in the art will realize other suitable implementations of client computers 24 for use with the subject invention.

At least one of the client computers 24 is in communication with the server computer 12 via at least one server-to-client communications link 26 such that data may be transferred between the at least one client computer 24 and the server computer 12. This communications link 26 may be implemented through the Internet, a dedicated point-to-point transmission line, a local area network (LAN), wireless devices, or other form of communication link known to those skilled in the art. The client computers 24 may be located remote from the server computer 12. Said another way, the healthcare provider location(s) 25 may be distant from the first and/or second locations 20, 22, where the server computer 12 is housed. Alternatively, the EHR database 16, the server computer 12, and the client computers 24 may all be housed at the healthcare provider location 25.

The plurality of client computers 24 may be in communication with one another via at least one client-to-client communications link 28. This communications link 28 may be implemented through the Internet, a dedicated point-to-point transmission line, a LAN, wireless devices, or other form of communication link known to those skilled in the art. Additionally, the client-to-client communications link 28 may utilize the same resources as the server-to-client communications link 26, e.g., the Internet. Of course, other computers (not shown) and devices (not shown), separate from the server and client computers 12, 24, may also be connected to the server-to-client and client-to-client communications links 26, 28.

The method of the subject invention includes the step of periodically transferring EHR data for patients from the EHR database 16 to the server computer 12. The period between transfers of the EHR data may be configurable based on the needs of the end users. For instance, the EHR data may be transferred from the EHR database 16 and the server computer 12 once every week, once every day, once every hour, or any other suitable period as known to those skilled in the art. The period between transfers may also be variable. As an example, the EHR data may be transferred once every two hours during the day (e.g., 6 A.M. to 6 P.M.) and once every six hours during the night. As the EHR data in the EHR database 16 has been transferred to the server computer 12, the method also includes the step of maintaining a copy of the EHR data of the EHR database 16 on the server computer 12.

During an initial setup (or restart) of the system 10, preferably all of the EHR data in the EHR database 16 is transferred to the server computer 12. After that initial setup (or restart), it is preferred that only new EHR data, which has changed since the previous transfer of EHR data, is transferred from the EHR database 16 to the server computer 12. As such, the step 102 of periodically transferring EHR data for all patients from the EHR database to the server computer is further defined as of periodically transferring only new EHR data which has changed since the previous transfer of EHR data. It is further preferred that the EHR data available on the server computer 12 is a full and complete copy of the EHR data which resides in the EHR database 16.

The method also includes the step of storing appointment data in the server computer 12. The appointment relates typically to a patient's appointment to see a physician or other health care provider. However, other types of appointments may also be accommodated by the system and method described herein. The appointment data includes at least a scheduled time of an appointment. The term “time” as used in this context refers to both the date and time of the appointment. The appointment data also preferably includes a patient identifier, e.g., a name of the patient, associated with the appointment. The appointment data may also include the geographical location of the appointment, the health care professional(s) involved in the appointment, and at least one category of EHR data necessary for the appointment. Other types of information associated with the appointment data are realized by those skilled in the art.

The method further includes the step of analyzing the appointment data to determine appointments scheduled within a range of times. This step is preferably performed by the server computer 12. The range of times is a “window” that is configurable based on the needs of the organization utilizing the system 10 and method. For example, the range of times may include all appointments that occurred in the previous 30 days or are pending in the next five days. Of course, other range of times may be utilized.

The method may also include the step of filtering the EHR data for each appointment to generate filtered EHR data. The filtering of the EHR data may be performed based in part on the appointment data. For instance, the EHR data may be filtered based on the at least one category of EHR data necessary for the appointment to generate filtered EHR data. As an example, an upcoming appointment for a particular patient may only require recent medical and diagnostic test data and not basic blood work from 12 years ago. As such, the appointment data may include categories relating only to the recent medical diagnostic test data. In another instance, the EHR data may be filtered based on the health care professional involved in the appointment. As an example, a cardiologist may be interested in cardiology notes, while an internist may be interested in notes from all specialties.

The method also includes the step of generating at least one electronic document from the EHR data that is readable by a health care provider. (For convenience purposes, the “at least one electronic document” may also be referred to herein as the “electronic document(s).”) Preferably, the at least one electronic document is created for each appointment scheduled within the range of times. However, in other embodiments, the at least one electronic document may be created for appointments scheduled outside the range of times. It is also preferred that the at least one electronic document is generated from the filtered EHR data. Said another way, the electronic document includes only the information necessary for the scheduled appointment based on the category or categories of the appointment. Furthermore, in the exemplary embodiment defined herein, the steps of filtering the EHR data and generating the electronic document(s) are both performed by a single software application running on the server computer 12. However, these steps may be performed by more than one software application.

In the exemplary embodiment, the electronic document is configured in the portable document format (commonly referred to as a PDF or the PDF format) which was created by Adobe Systems of San Jose, Calif., and is now an open standard managed by the International Organization for Standardization (ISO) of Geneva, Switzerland. PDF documents are easily viewable on and printable from a variety of operating systems. Of course, the electronic document generated from the EHR data may be of a different format, as is well known to those skilled in the art.

The method also includes the step of generating at least one list of the at least one electronic documents available on the server computer. The list(s) may include which of the client computer(s) may require each electronic document. This information (i.e., which client computer(s) need each document) may be automatically or manually generated when an appointment is generated. As such, the lists(s) are generated and regenerated routinely as appointments are made and electronic document(s) are generated. In the exemplary embodiment described herein, the list(s) are transferred, i.e., communicated, to each of the client computers 24 for use as described in detail below. However, in alternative embodiments, the list(s) need not necessarily be communicated to the client computers 24.

The method further includes the step of communicating the at least one electronic document to at least one of the client computers 24. As such, the client computer 24 receives the EHR data in an easy-to-read and printable document, analogous to the “charts” commonly used by health care professionals. As such, the system 10 may include one or more printers 30 in communication with the client computer(s) 24 for printing the electronic documents.

In the exemplary embodiment, the step of communication the at least one electronic document to at least one of the client computers 24 utilizes a unique process. First, each client computer 24 receives the most recent list(s) of electronic documents available on the server computer 12. More specifically, each client computer 24 regularly requests the most recent list(s) to be downloaded from the server computer 12. As such, the method further includes the step of transferring the list of the electronic documents to at least one of the client computers 24 wherein the list indicates which of the client computers 24 require which of the electronic documents.

Next, each client computer 24 having a copy of the list analyzes that list to determine which of the electronic documents is required at that client computer 24. If the client computer 24 does not have a copy of one or more of the required electronic documents, then the client computer 24 polls other client computers 24 to determine if one or more of the other client computers 24 have the required electronic documents.

If one of the other client computers 24 has the electronic document required by the client computer 24, then the required electronic document is communicated, i.e., downloaded, from the one or more of the other client computers 24 to the client computer 24 requiring the electronic document. However, if none of the other client computers 24 has the electronic document required by the client computer, 24 the required electronic document is communicated from the server computer 12 to the client computer 12.

As such, electronic documents are typically communicated from the server computer 12 a small number of the client computers 24, preferably only one client computer 24. The electronic documents are then transferred between the client computers 24. This technique helps to conserve bandwidth on the server-to-client communications link 26. This bandwidth preservation is especially important when large volumes of data are being transferred and/or when communication along the communications link 26 is charged based on the volume of data that is transferred. Furthermore, this technique provides for a generally more efficient transfer of the electronic documents to the various client computers 24. Moreover, this technique allows for transfer of the electronic document(s) between client computers 24 even if communication is lost between the client computers 24 and the server computer 12.

As stated above, the EHR data is transferred periodically between the EHR database 16 and the server computer 12. The EHR data in these periodic transfers may be additional EHR data or may supplant or countermand the EHR data residing on the server computer 12. That is, the EHR data may be updated for a wide variety of reasons. As a few examples: a new blood test result for a patient may be added to the EHR data, an examination of the patient by a different physician may be recorded, and/or an MRI image may be added.

As the EHR data is updated, the document(s) generated from the EHR data may also need to be updated. As such, the method also includes the step of determining if the at least one electronic document needs to be updated based on the new EHR data received at the server computer 12.

Several substeps may be involved in determining if the electronic document(s) need to be updated. First, it is determined whether the appointment of the patient to which the at least one electronic document refers is still scheduled within the range of times of the required appointments. If the appointment of the patient is not within this range of times, then the electronic document(s) need not be updated. Furthermore, the electronic document(s) may be deleted from the server computer 12.

However, if the appointment does fall within the range of times and the EHR data is in the at least one category, then the method proceeds with the step of attaching a tag to each electronic document which does not include the most recent EHR data available from the EHR database 16. This tag may be simply a data bit or other data field which is part of the electronic document. Said another way, each electronic document which no longer contains the most recent EHR data may be marked as “stale”.

The method further includes the step of generating at least one new electronic document including the new EHR data for each appointment scheduled within the range of times. As such, at least two electronic documents may reside on the server computer 12 relating to a single appointment: one document with the latest EHR data and another document with old EHR data and tagged as such.

As the electronic documents are updated as described above, the at least one list of the at least one electronic documents available on the server computer 12 are also updated. Furthermore, electronic documents that are tagged as stale are excluded from the list(s) and replaced by the electronic documents having the new EHR data.

As stated above, each client computer 24 regularly requests the most recent list(s) available on the server computer 12. If a stale document on the document has been replaced with an updated electronic document, the client computer 24 downloads the updated electronic document and overwrites, i.e., deletes, the stale electronic document.

The method may also include the step of deleting the electronic document(s) for appointments scheduled outside the range of times from the server computer 12 and the step of deleting the electronic document(s) for appointment scheduled outside the range of times from the client computers(s) 24. As storage space on the server computer 12 and the client computer(s) 24 is not finite, deletion of the document(s) helps free space for other electronic document(s), EHR data, appointment data, or other data. Furthermore, deletion of the document(s) ensures that the document(s) relating to a particular patient need not be tagged and a new document created for a patient making a new appointment at a later time; thus, saving computation time at the server computer 12 and/or the client computer(s) 24.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method of organizing and distributing electronic healthcare record (EHR) data using a computerized system, the system including a server computer in communication with an EHR database, said method comprising the steps of:
periodically transferring EHR data from the EHR database to the server computer;
storing appointment data in the server computer wherein the appointment data includes a scheduled time of an appointment and at least one category of EHR data necessary for the appointment;
analyzing the appointment data to determine appointments scheduled within a range of times;
filtering the EHR data for each appointment based on the at least one category of EHR data necessary for the appointment to generate filtered EHR data; and
generating at least one electronic document that is readable by a health care provider and includes the filtered EHR data for each appointment scheduled within the range of times.

2. A method as set forth in claim 1 wherein the system further includes a plurality of client computers in communication with the server computer and further comprising the step of communicating the at least one electronic document from the server computer to at least one of the client computers.

3. A method as set forth in claim 2 further comprising the step of transferring the at least one electronic document from the one of the client computers to another of the client computers.

4. A method as set forth in claim 1 wherein the system further includes a plurality of client computers in communication with the server computer and the at least one electronic document is further defined as a plurality of electronic documents and further comprising the step of transferring a list of the electronic documents to at least one of the client computers wherein the list indicates which of the client computers require which of the electronic documents.

5. A method as set forth in claim 4 further comprising the steps of determining which of the electronic documents is required by the at least one client computer and polling other of the client computers to determine if any of the required electronic documents are available at one or more of the other client computers.

6. A method as set forth in claim 5 further comprising the step of communicating any of the required electronic documents to the at least one client computer from any of the other client computers if those electronic documents are available at any of the other client computers.

7. A method as set forth in claim 5 further comprising the step of communicating any of the required electronic documents to the at least one client computer from the server computer if those electronic documents are not available at any of the client computers.

8. A method as set forth in claim 1 wherein said step of periodically transferring EHR data from the EHR database to the server computer is further defined as periodically transferring only new EHR data which has changed since the previous transfer of EHR data.

9. A method as set forth in claim 1 further comprising the step of determining if the at least one electronic document needs to be updated based on the new EHR data received at the server computer.

10. A method as set forth in claim 9 wherein said step of determining if the at least one electronic document needs to be updated further comprises the step of determining whether the appointment to which the at least one electronic document refers is still scheduled within the range of times.

11. A method as set forth in claim 10 further comprising the steps of
attaching a tag to each electronic document which does not include the most recent EHR data available from the EHR database, and
generating at least one new electronic document including the new EHR data for each appointment scheduled within the range of times and that is readable by a health care provider.

12. A method as set forth in claim 11 further comprising the step of communicating the at least one new electronic document from the server computer to at least one of the client computers.

13. A method as set forth in claim 1 further comprising the step of attaching a tag to each electronic document in the server computer which does not include the most recent EHR data available from the EHR database to indicate that the electronic document does not include the most recent EHR data available from the EHR database.

14. A method as set forth in claim 1 further comprising the step of deleting from the server computer the electronic documents for each appointment scheduled outside the range of times.

15. A method as set forth in claim 2 wherein at least one of the client computers is remote from server computer.

16. A method of distributing electronic healthcare record (EHR) data using a computerized system, the system including a server computer in communication with an EHR database, a plurality of client computers in communication with the server computer, said method comprising the steps of:
periodically transferring EHR data from the EHR database to the server computer;
generating at least one electronic document from the EHR data for each appointment that is readable by a health care provider;
communicating the at least one electronic document from the server computer to at least one of the client computers.
transferring the at least one electronic document from the at least one of the client computers to another of the client computers separate from the at least one of the client computers.

17. A method as set forth in claim 16 further comprising the step of filtering the EHR data for each appointment to generate filtered EHR data and wherein said step of generating at least one electronic document is further defined as generating at least one electronic document from the filtered EHR data.

18. A method of organizing and distributing electronic healthcare record (EHR) data using a computerized system, the system including a server computer in communication with an EHR database, said method comprising the steps of:
maintaining a copy of the EHR data on the server computer;
maintaining at least one electronic document generated from the EHR data on the server computer;
periodically transferring from the EHR database to the server computer only new EHR data which is different from the EHR data on the server computer;
determining if the at least one electronic document needs to be updated based on the new EHR data received at the server computer; and
generating at least one new electronic document including the new EHR data in response to the determination that the at least one electronic document needs to be updated.

19. A method as set forth in claim 18 further comprising the step of attaching a tag to each electronic document which does not include the most recent EHR data available from the EHR database.

20. A method as set forth in claim 18 further comprising the step of communicating the at least one new electronic document from the server computer to at least one of the client computers.
